(19) United States
(12) Patent Application Publication
(10) Pub. No.: US 2008/0062593 A1
(43) Pub. Date: Mar. 13, 2008

(54) LEAKAGE CURRENT DETECTION AND PROTECTION CIRCUIT FOR A POWER PLUG

(75) Inventors: Cheng-Li Li, Shanghai (CN); Guo-Lan Yue, Shanghai (CN); Long Zhang, Changhai (CN)

Correspondence Address: YING CHEN;Chen Yoshimura LLP, 255 S. GRAND AVE., # 215, LOS ANGELES, CA, 90012, US

(73) Assignee: SHANGHAI ELE MANUFACTURING CORP., Shanghai (CN)

(21) Appl. No.: 11/758,192

(22) Filed: Jun. 5, 2007

(30) Foreign Application Priority Data
Sep. 12, 2006 (CN) 200620129774.5

(51) Int. Cl. H02H 3/16

(52) U.S. Cl. 361/46

(57) ABSTRACT

A leakage current detection and protection circuit in a power plug includes an SCR (silicon-controller rectifier), diodes, capacitor, resistors, and a solenoid with a plunger. The control gate of the SCR is connected via a resistor to a metal sheath L of the cord. The solenoid SOL, the SCR and a diode are connected in series and connected across the hot and neutral lines of the power line (either line or load side), forming an SCR conducting path. When wire for the hot, neutral or ground lines in the cord is exposed due to damage or aging, the sheath around the wires becomes live, forming a conducting circuit from the sheath, resistors and diodes to the hot or neutral lines. The voltage on the resistor causes the SCR to conduct, which energizes the solenoid to open a switch between the line side and load sides of the plug.

This application claims foreign priority benefits under 35 U.S.C. § 119(a)-(d) from China Patent Application No. 200620129774.5, filed Sep. 12, 2006, which is incorporated by reference in its entirety.

### BACKGROUND OF THE INVENTION

1. Field of the Invention

This invention relates to a leakage current detection and protection circuit in a power plug for detecting a leakage current in the cord between the power plug and the load.

2. Description of the Related Art

With the wide use of household electrical appliances, such as air conditioners, washing machines, refrigerators, etc., more attention is being paid to the safety of using such appliances. An appliance typically has a power cord of one meters or longer with a power plug. Such power cord may age due to long-term use, or become damaged when the appliance is moved, which may cause a leakage between the hot line and the neutral or ground lines in the cord. Such leakage current may cause sparks, which may cause fire and property damages. It is therefore highly desirable to provide a leakage current detection and protection circuit in the power plug for detecting any leakage current in the cord between the power plug and the appliance due to exposed wires, and further for cutting off the power supply to the appliance via a switch. Such a circuit can prevent fire and related property damages.

### SUMMARY OF THE INVENTION

Accordingly, the present invention provides a leakage current detection and protection circuit in a power plug which has a relatively simple structure and can detect leakage current in the cord caused by exposed hot, neutral or ground lines due to damaged cords.

To achieve this and other objects and in accordance with the purpose of the present invention, as embodied and broadly described, the present invention provides a leakage current detection and protection circuit for a power plug having a cord with a metal sheath, the power plug including line side hot and neutral lines and load side hot and neutral lines, the circuit including: a silicon-controller rectifier (SCR) having an anode, a cathode and a control gate, a first and a second diode, a capacitor, a first and a second resistor, and a solenoid with a plunger, wherein a control gate of the SCR is connected via the first resistor to the metal sheath, wherein the solenoid, the SCR and the first diode are connected in series and connected across the line side hot and neutral lines or load side hot and neutral lines to form an SCR conducting path, wherein the second resistor and the capacitor are connected in parallel between the control gate and the cathode of the SCR, and wherein the second diode is connected between the anode and the cathode of the SCR.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a circuit diagram showing a leakage current detection and protection circuit according to an embodiment of the present invention.

FIG. 2 is a circuit diagram showing a leakage current detection and protection circuit according to another embodiment of the present invention.

### DETAILED DESCRIPTION OF THE PREFERRED EMBODIMENTS

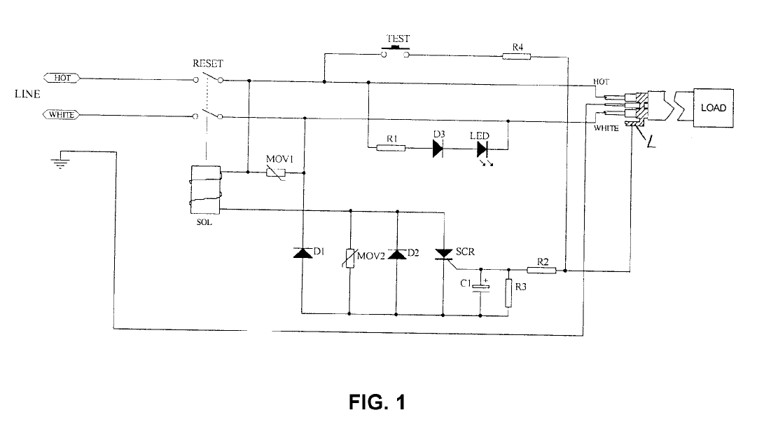

As shown in FIG. 1, the leakage current detection and protection circuit includes an SCR (silicon-controller rectifier), diodes D1 and D2, capacitor C1, resistors R2 and R3, and a solenoid SOL with a plunger. The control gate of the SCR is connected via resistor R2 to a metal sheath L (also referred to as a shield line) of the cord. The solenoid SOL is connected in series with the SCR and diode D1 and connected across the hot line HOT and neutral line WHITE of the power plug (either on the line side or on the load side), forming an SCR conducting path. Connected in parallel between the control gate and the cathode of the SCR is resistor R3 and charging capacitor C1. Connected between the anode and the cathode of the SCR is diode D2.

In the circuit shown in FIG. 1, the control gate of the SCR is connected via resistor R2 to the metal sheath L of the cord. The solenoid SOL is connected at one end to the hot line HOT of the load side of the plug, and connected at the other end to the anode of the SCR. The cathode of the SCR is connected to the anode of the diode D1, and the cathode of the diode D1 is connected to the neutral line WHITE of the load side of the plug. Thus, the solenoid SOL, SCR, diode D1 are connected in series across the hot and neutral lines HOT and WHITE of the load side of the power plug.

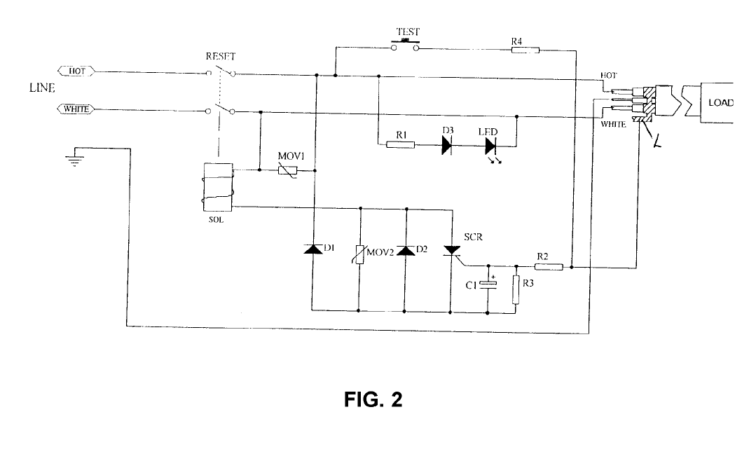

In the circuit shown in FIG. 2, the control gate of the SCR is connected via resistor R2 to a metal sheath L of the cord. The solenoid SOL is connected at one end to the neutral line WHITE of the load side of the plug, and connected at the other end to the anode of the SCR. The cathode of the SCR is connected to the anode of the diode D1, and the cathode of the diode D1 is connected to the hot line HOT of the load side of the plug. Thus, the solenoid SOL, SCR, diode D1 are connected in series across the hot and neutral lines HOT and WHITE of the load side of the power plug.

Although not shown in the drawings, the SCR conducting path formed by the solenoid SOL, the SCR and the diode D1 may also be connected across the line side hot and neutral lines. The line side and the load side are connected by a reset switch SW.

As shown in FIGS. 1 and 2, when no leakage current is present between the hot line HOT and the neutral line WHITE or the ground line of the cord (the load side), the SCR does not conduct, and no current flows through the solenoid SOL. The power plug functions normally in this situation. When the hot line HOT, the neutral line WHITE or the ground line of the cord is exposed due to aging or damage, the sheath L becomes live, resulting in a conducting circuit including the sheath L, resistors R2 and R3, capacitor C1, and diodes D1 or D2. This conducting circuit results in a positive voltage drop across the resistor R3, triggering the SCR into a conductive state. As a result, the solenoid is energized, activating the plunger to open the reset switch SW, cutting off the electrical connection between the line side LINE and the load side LOAD of the power plug. Power to the load is therefore cut off.

For example, in FIG. 1, if a leakage occurs between the sheath L and the hot line HOT of the cord, during the positive half cycle of the hot line HOT, a forward current flows from the sheath L through resistor R2, resistor R3, diode D1 to the neutral line WHITE, resulting in a positive voltage drop across resistor R3. When the voltage across R3 exceeds the threshold voltage for the SCR, the SCR becomes conductive. Because it is the positive half cycle of the power line, the anode voltage of the SCR is higher than its cathode voltage, the SCR conducts current from its anode to its cathode. The solenoid SOL is energized, activating the plunger to open the reset switch SW, cutting off the electrical connection between the line side LINE and the load side LOAD of the power plug.

If a leakage occurs between the sheath L and the neutral line WHITE of the cord, during the negative half cycle of the hot line HOT, a forward current flows from the sheath L through resistor R2, resistor R3, diode D2, the solenoid SOL to the hot line HOT, resulting in a positive voltage drop across resistor R3. When the voltage across R3 exceeds the threshold voltage for the SCR, the SCR becomes conductive. However, because it is the negative half cycle of the power line, the anode voltage of the SCR is lower than its cathode voltage, current does not flow from the anode to the cathode of the SCR. The forward current from the sheath L therefore charges the capacitor C1, until the power goes from the negative half cycle to the positive half cycle. When the power goes into the positive half cycle, charging stops and the capacitor C1 starts to discharge. Accordingly, the voltage across the resistor R3 diminishes gradually. Because at this time the anode voltage of the SCR is higher than its cathode voltage, when the control gate voltage of the SCR still exceeds the threshold voltage for the SCR, the SCR becomes conductive. As a result, the solenoid SOL is energized, activating the plunger to open the reset switch SW, cutting off the electrical connection between the line side LINE and the load side LOAD of the power plug.

A leakage current detection and protection circuit according to embodiments of the present invention has the advantages of structural simplicity, low cost, and reliability. It can quickly and accurately detect the leakage current in the power cord for an appliance, quickly cut off power supply in the event of a current leakage, thereby protecting the appliance and the safety of the user.

It will be apparent to those skilled in the art that various modification and variations can be made in the power plug embodiment of the present invention without departing from the spirit or scope of the invention. Thus, it is intended that the present invention cover modifications and variations that come within the scope of the appended claims and their equivalents.

What is claimed is:

1. A leakage current detection and protection circuit for a power plug having a cord with a metal sheath, the power plug including line side hot and neutral lines and load side hot and neutral lines, the circuit comprising:
a silicon-controller rectifier (SCR) having an anode, a cathode and a control gate, a first and a second diode, a capacitor, a first and a second resistor, and a solenoid with a plunger,
wherein a control gate of the SCR is connected via the first resistor to the metal sheath,
wherein the solenoid, the SCR and the first diode are connected in series and connected across the line side hot and neutral lines or load side hot and neutral lines to form an SCR conducting path,
wherein the second resistor and the capacitor are connected in parallel between the control gate and the cathode of the SCR, and
wherein the second diode is connected between the anode and the cathode of the SCR.

2. The leakage current detection and protection circuit of claim 1,
wherein the solenoid is connected at one end to the load side hot line, and connected at another end to the anode of the SCR,
wherein the cathode of the SCR is connected to an anode of the first diode, and
wherein a cathode of the first diode is connected to the load side neutral line, whereby the SCR conducting path is formed.

3. The leakage current detection and protection circuit of claim 1,
wherein the solenoid is connected at one end to the load side neutral line, and connected at another end to the anode of the SCR,
wherein the cathode of the SCR is connected to an anode of the first diode, and
wherein a cathode of the first diode is connected to the load side hot line, whereby the SCR conducting path is formed.

4. The leakage current detection and protection circuit of claim 1,
wherein the solenoid is connected at one end to the line side hot line, and connected at another end to the anode of the SCR,
wherein the cathode of the SCR is connected to an anode of the first diode, and
wherein a cathode of the first diode is connected to the line side neutral line, whereby the SCR conducting path is formed.

5. The leakage current detection and protection circuit of claim 1,
wherein the solenoid is connected at one end to the line side neutral line, and connected at another end to the anode of the SCR,
wherein the cathode of the SCR is connected to an anode of the first diode, and
wherein a cathode of the first diode is connected to the line side hot line, whereby the SCR conducting path is formed.

6. The leakage current detection and protection circuit of claim 1,
wherein the first resistor, which is connected between the control gate of the SCR and the metal sheath, is connected in series with the second resistor, which is connected between the control gate and the cathode of the SCR.

7. The leakage current detection and protection circuit of claim 1, further comprising a switch for connecting the line side hot and neutral lines to the load side hot and neutral lines, respectively, wherein the solenoid opens the switch when energized.
